(19) United States
(12) Patent Application Publication
(10) Pub. No.: US 2008/0127324 A1
(43) Pub. Date: May 29, 2008

(54) DDoS FLOODING ATTACK RESPONSE APPROACH USING DETERMINISTIC PUSH BACK METHOD

(75) Inventors: Jung-Taek Seo, Taejon (KR); Kiwook Sohn, Taejon (KR); Eungki Park, Taejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Taejon (KR)

(21) Appl. No.: 11/860,625

(22) Filed: Sep. 25, 2007

(30) Foreign Application Priority Data
Nov. 24, 2006 (KR) 10-2006-0116654
Jul. 18, 2007 (KR) 10-2007-0071865

(51) Int. Cl. G06F 21/00

(52) U.S. Cl. 726/13

(57) ABSTRACT

Provided is a method for responding a distributed denial of service (DDoS) attack using deterministic pushback scheme. In the method, all of packets outbound from an edge router of a predetermined network system to the other network system are marked with own IP address in order to enable a victim system to confirm an IP address of an attack source edge router for DDoS attack packets. Then, IP address information of an attack source edge router is obtained by reassembling an IP address of detected DDoS attack packets at a victim system that detects DDoS attack. A deterministic pushback message is received at an attack source edge router if a victim system transmits a deterministic pushback message to the attack source edge router, information of the attack source edge router is confirmed, and corresponding attack packets are filtered.

### BACKGROUND OF THE INVENTION

1. Field of the Invention

The present invention relates to a network security technology, and more particular to a method for responding a distributed denial of service (DDoS) attack using deterministic pushback, which can effectively and automatically respond DDoS attach that incapacitates a network system by transmitting a huge amount of packets at the same time to make a network system not to provide services normally.

2. Description of the Related Art

A proactive traceback technology is one of technologies for responding a distributed denial of service (DDoS) attack traceback. In the proactive traceback technology, traceback information is generated in a packet transmission process, and the generated information is inserted and transferred. The proactive traceback technology includes a packet marking scheme for probabilistically marking an own IP address in packets at routers while the packets are transmitting and an internet control message protocol (ICMP) traceback message based traceback scheme, where ICMP stands for internet control message protocol. These technologies not only request all of routers to have a predetermined module for reconfiguring a trackback path but also generate large load. Particularly, these technologies have difficulty in quickly response to DDoS attacks generated from many attack sources.

The reactive traceback technology includes Hop-by-Hop traceback and hash based IP traceback that traceback an attack source with the connection of the attack source sustained when a hacking attack is detected. Since these technologies need an additional management system for a router or a predetermined module assigned to a router, the large amount of load is generated at the management system and the router.

### SUMMARY OF THE INVENTION

Accordingly, the present invention is directed to a DDoS flooding attack response approach using deterministic push back method, which substantially obviates one or more problems due to limitations and disadvantages of the related art.

It is an object of the present invention to a method for responding a distributed denial of service (DDoS) attack using a deterministic pushback scheme, which marks all of packets generated at an edge router with the IP address of the edge router and filters attacking packets at an attack source edge router by confirming the IP address of the attack source edge router through IP-reassembling at a victim system and transmitting deterministic push back message to the attack source edge router without additional modules are installed at all of backbone routers or without an additional management system is employed for responding DDoS attack using an IP spoofing scheme.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for responding a distributed denial of service (DDoS) attack using a deterministic pushback scheme, including the steps of: a) marking all of packets outbound from an edge router of a predetermined network system to the other network system with own IP address in order to enable a victim system to confirm an IP address of an attack source edge router for DDoS attack packets; b) obtaining IP address information of an attack source edge router by reassembling an IP address of detected DDoS attack packets at a victim system that detects DDoS attack; and c) receiving a deterministic pushback message at an attack source edge router if a victim system transmits a deterministic pushback message to the attack source edge router, confirming information of the attack source edge router, and filtering corresponding attack packets.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a diagram illustrating a network system where a method for responding DDoS attack using deterministic pushback according to an embodiment of the present invention is applied;

FIG. 2 is a flowchart illustrating a method for responding Distributed Denial of Service (DDoS) attack using deterministic pushback according to an embodiment of the present invention;

FIG. 3 is a diagram illustrating a procedure of marking an own IP to packets at an edge router according to an embodiment of the present invention;

FIG. 4 is a diagram illustrating a procedure of reassembling an IP address using a chain structure in a victim system according to an embodiment of the present invention; and

FIG. 5 is a diagram illustrating a format of a Pushback message transmitted to an attack source edge router from a victim system according to an embodiment of the present invention.

### DETAILED DESCRIPTION OF THE INVENTION

Reference will now be made in detail to the preferred embodiments of the present invention, examples of which are illustrated in the accompanying drawings.

Referring to FIG. 1, network systems, where a method for responding DDoS attack using deterministic pushback is applied to, are divided into attacker systems a1, and a2, and a victim system. Each of the network systems includes a plurality of edge routers r1, r2, and r3, and a plurality of the other routers r4, r5, and r6 which are included in a network of each system.

In the present embodiment in FIG. 1, edge routers r1 and r2 are attack source routers.

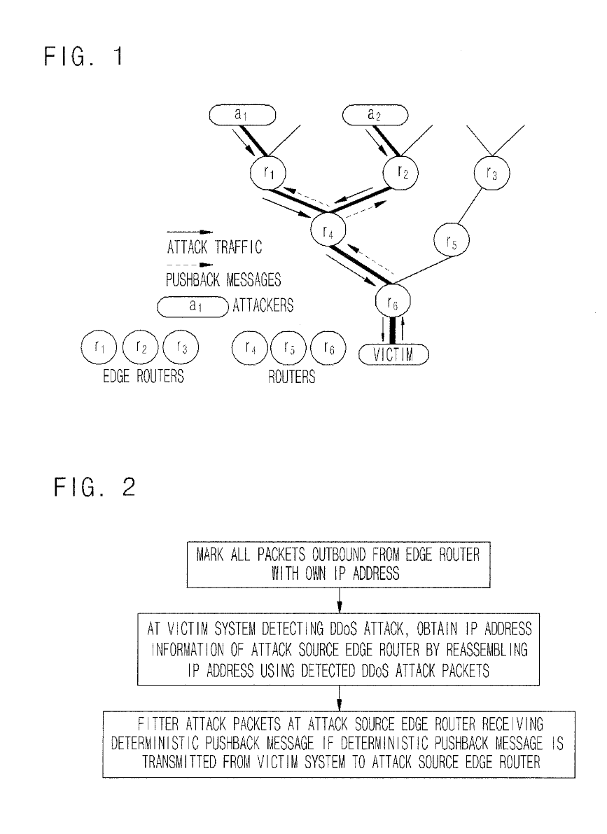

A method for responding DDoS attack using a deterministic pushback scheme according to an embodiment of the present invention will be described with reference FIG. 2 through FIG. 5.

Referring to FIG. 2, at step S100, the edge routers r1, r2, and r3 of a predetermined network system mark all of packets outbound to the other network systems with own IP addresses in order to enable a victim system to confirm the IP address of an attack source edge router for DDoS attack packets.

In typical Internet structure, there is no field provided for indicating the IP address information of the edge routers r1, r2, and r3. Therefore, each of the edge routers r1, r2, and r3 according to the present embodiment uses a method for inserting the IP address information of edge routers r1, r2, and r3 in an identification field and a type of service field, which are option fields having null value. The option fields of the typical Internet structure are used to prevent the size of a packet from increasing.

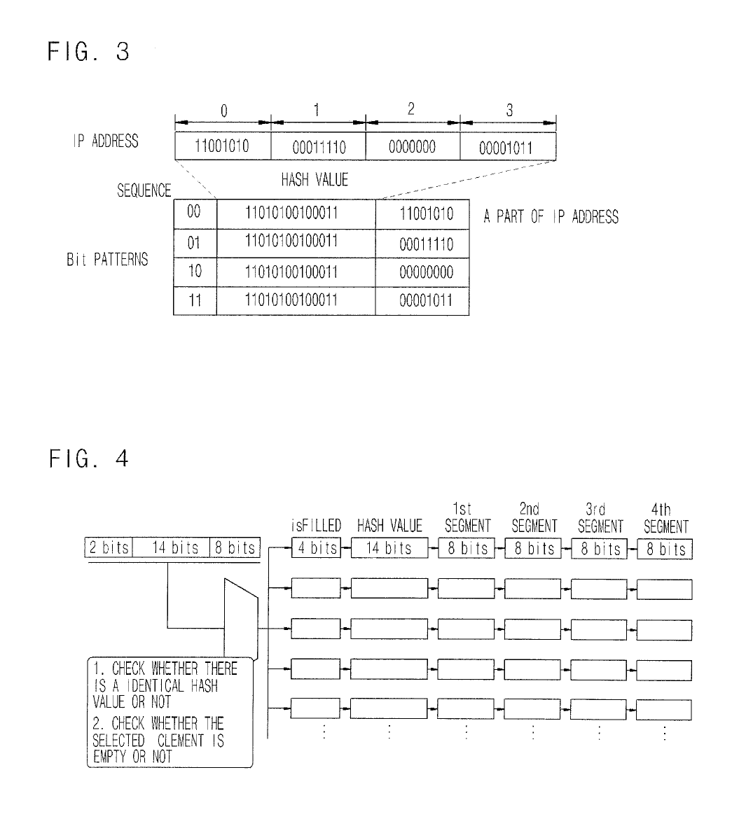

FIG. 3 is a diagram illustrating a procedure of marking an own IP to packets at an edge router according to an embodiment of the present invention. Since the total size of the two operation fields is 24 bits, it is insufficient to contain 32 bit IP address information. In the present embodiment, the IP address information is divided into four parts as one bit pattern, and each of the four parts is stored in each packet.

The one bit pattern is formed of three parts, sequence, hash value of the IP address, 8-bits of 32-bits IP address.

Two bits are used for the part of the sequence. A sequence bit ‘01’ denotes the second part of the 32-bit IP address, that is, IP address information from the 9^{th} bit to the 16^{th} bit.

The part of the hash value of the IP address uses 14 bits to store a hash value for the IP address of an edge router.

The part of 8 bits of 32 bits IP address store the 8-bit information among the IP address information for a corresponding sequence.

If a predetermined victim system detects DDoS attack when the edge routers r1, r2, and r3 mark all of packets outbound to the other network systems with own IP addresses at the step S100, the IP address information of attack source edge routers r1 and r2 are obtained by reassembling an IP address using the detected DDoS attack packets at the victim system detecting the DDoS attack at step S200.

FIG. 4 is a diagram illustrating a procedure of reassembling an IP address using a chain structure in a victim system according to an embodiment of the present invention.

As shown in FIG. 4, in order to reassemble an IP address, it uses a linked-list structure that classifies by checking a hash value for an IP address extracted from the Identification field and a Type of Service field of attach packets. Each of lists is formed of six fields.

The first four bits are a classification field, and the next 14-bits are a hash value filed having a hash value for the IP address. Then, the next 8-bit field stores one part of 32-bits IP address, which is divided into four parts.

After the IP address information of the attack source edge router is obtained by performing the reassembling process, the victim system can identify edge routers r1 and r2 using the hash value.

After the IP address information of attack source edge routers r1 and r2 are obtained by reassembling an IP address using the detected DDoS attack packets at the victim system detecting the DDoS attack at step S200, a deterministic pushback message is transmitted from the victim system to the attack source edge router. Then, the attack source edge routers r1 and r2, which receive the deterministic pushback message, confirm the related information and perform a filtering process on corresponding attack packets at step S300.

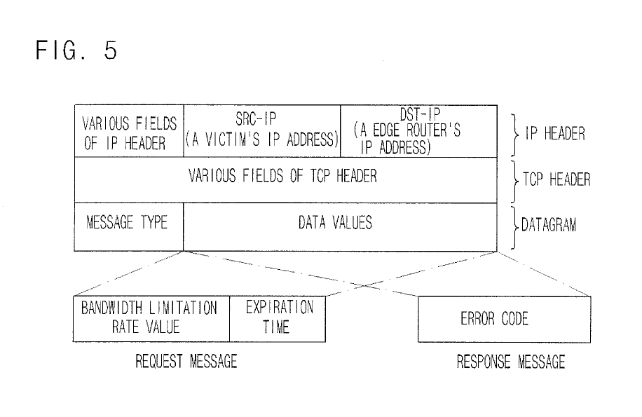

FIG. 5 is a diagram illustrating a format of a Pushback message used for filtering corresponding attack packets after the IP address information of the attack source edge routers r1 and r2 is obtained at the victim system, the deterministic pushback message is transmitted to the attack source edge routers r1 and r2, and the related information is confirmed at the attack source edge routers r1 and r2.

In FIG. 5, an IP header field stores the IP address information of a victim system as a source IP address (src-IP), and the IP address information of a target edge router as a destination IP address (dst-IP). Various fields may be defined in a TCP header.

A datagram includes a bandwidth limitation rate value field, an expiration time field, and an error code field.

The bandwidth limitation rate value field stores information about a bandwidth limitation rate for packets transmitted to a victim system. The expiration time field stores time information for sustaining an edge router in a filtering state. Edge routers generating attack packets filter corresponding packets using the information in the Pushback message transmitted from a victim system.

As described above, the edge routers r1 and r2 generating and transmitting packets mark predetermined fields with the own IP addresses. Then, the victim system confirms the IP addresses of the attack source edge routers r1 and r2 by reassembling packet information and transmit the deterministic pushback message for packet-filtering to the attack source edge routers r1 and r2. Then, the attack source edge routers r1 and r2 receives the deterministic pushback message and filters corresponding attack packets.

It will be apparent to those skilled in the art that various modifications and variations can be made in the present invention. Thus, it is intended that the present invention covers the modifications and variations of this invention provided they come within the scope of the appended claims and their equivalents.

In the method for responding DDoS attack using a deterministic pushback scheme according to an embodiment of the present invention, the IP address of an attack source edge router is confirmed without additional modules are installed in all backbone routers and without an additional management system is employed in a network, and the attack source edge router is enabled to filter DDoS attack packets. Therefore, it makes possible to filter attack packets entering a network at the attack source and to effective respond DDoS attack without the participation of intermediate routers.

Since it is possible to confirm the IP address of the attack source edge router according to the present invention when the DDoS attack occurs, it can minimize overhead for tracing back the attack source by interacting with all routers in a network, for example, confirming marking information of intermediate routers. Since most of DDoS attack uses IP spoofing attack, it is difficult to detect the attack source thereof. In the present invention, trackback is performed using the IP address information of the source edge router, and packets generated at the attack source are filtered. Therefore, it prevents the attack packets from entering a network at the source, and it is possible to quickly respond the DDoS attack using the IP spoofing scheme.

What is claimed is:

1. A method for responding a distributed denial of service (DDoS) attack using a deterministic pushback scheme, comprising the steps of:
a) marking all of packets outbound from an edge router of a predetermined network system to the other network system with own IP address in order to enable a victim system to confirm an IP address of an attack source edge router for DDoS attack packets;
b) obtaining IP address information of an attack source edge router by reassembling an IP address of detected DDoS attack packets at a victim system that detects DDoS attack; and
c) receiving a deterministic pushback message at an attack source edge router if a victim system transmits a deterministic pushback message to the attack source edge router, confirming information of the attack source edge router, and filtering corresponding attack packets.

2. The method of claim 1, wherein in the step a), an edge router of a predetermined network system stores IP address information of the edge router in an Identification field and a Type of Service field, which are option fields having null value in IP or TCP protocol, as one bit pattern which is divided in four parts.

3. The method of claim 2, wherein when the edge router of the predetermined network system stores the IP address information into each of packets that passes the edge router, the one bit pattern includes a sequence part, a hash value of the IP address part, a 8-bits of 32-bits IP address part.

4. The method of claim 1, wherein the IP address information of an attack source edge router is obtained by reassembling an IP address using a linked-list structure that classifies by checking a hash value for an IP address extracted from the Identification field and the Type of Service field of attack packets in a victim system that detects DDoS attack.

5. The method of claim 4, wherein when the IP address information of an attack source edge router is obtained by reassembling an IP address using a linked-list structure that classifies by checking a hash value for an IP address extracted from the Identification field and the Type of Service field of attack packets in a victim system that detects DDoS attack, the linked-list structure includes 4-bits of a classification field, 14-bits of a hash value field having a hash value for IP address, and four 8-bits fields for storing an IP address.

6. The method of claim 1, wherein in the step c), the deterministic pushback message is transmitted to an attack source edge router, and the deterministic pushback message includes an IP header having IP address information of a victim system as a source IP address (src-IP) and IP address information of a target edge router as a destination IP address (dst-IP), and a datagram having a bandwidth limitation rate value, an expiration time, and an error code.
